(19) United States
(12) Patent Application Publication
(10) Pub. No.: US 2021/0260772 A1
(43) Pub. Date: Aug. 26, 2021

(54) CENTRING BODY AND METHOD FOR THE ALIGNMENT THEREOF

(71) Applicant: ESE-ROBOTICS GmbH, Jena (DE)

(72) Inventors: Steffen Eckardt, Waltersdorf (DE); Ronny Doerrbeck, Gera (DE)

(21) Appl. No.: 17/315,004

(22) Filed: May 7, 2021

Related U.S. Application Data
(63) Continuation of application No. PCT/EP2019/080554, filed on Nov. 7, 2019.

(30) Foreign Application Priority Data
Nov. 7, 2018 (DE) 10 2018 008 884.8

(51) Int. Cl. B25J 9/16

(52) U.S. Cl. CPC B25J 9/1697; B25J 9/1674; B25J 9/1664; B25J 9/1653

(57) ABSTRACT

A centring body is inserted into a reference opening of a component along the longitudinal axis of the centring body. The centring body includes an objective lens defining an optical axis which coincides with the longitudinal axis. A smart measure arrangement including the centring body and an industrial robot including such an arrangement are also disclosed as is a method for relatively aligning the centring body.

### CROSS REFERENCE TO RELATED APPLICATIONS

This application is a continuation application of international patent application PCT/EP2019/080554, filed Nov. 7, 2019, designating the United States and claiming priority from German application 10 2018 008 884.8, filed Nov. 7, 2018, and the entire content of both applications is incorporated herein by reference.

### TECHNICAL FIELD

The disclosure relates to a centring body, a method for its relative alignment, an arrangement including a centring body, and an industrial robot. The centring body, the arrangement and the method are, in particular, suitable for the particularly preservative picking of components.

### BACKGROUND

From the field of quality control in the assembly of individual components and subassemblies in vehicle construction, the so-called reference point system is known. The reference point system is a concept with fixed rules for a uniform design, designation and representation of reference points and component reference systems on components in the entire manufacturing process of a vehicle. The reference point system as well as the shape and positional tolerances constitute the methodical basis of the geometric precision in frame-and-body construction and vehicle assembly. With the aid of the reference point system, components can be arranged in a defined geometric position.

The reference point system ensures a distinct and reproducible positioning of individual components, subassemblies, or systems in the entire manufacturing process of a vehicle. The relative positional relations of the components mounted and to be mounted are clearly defined. The reference points, for example RPS receiving holes, constitute the required references for a shape and positional orientation. Thus, the tolerances of the individual components can be exactly described throughout the entire manufacturing and inspection process. The reference point system serves as the basis of the tolerance concepts in tolerance management.

Damage to RPS receiving holes during the production process has to be avoided in general—particularly when industrial robots such as, for example, assembly robots are used. Otherwise, there will be deterioration in quality. However, such damage cannot be excluded in prior art. The pick-up position, that is, the relative position in which an industrial robot takes up a component, is hardwired to the respective robot. Even in case of a “search component” routine, only a relatively imprecise determination of the position of the component to be picked up will be performed, for example via 3D probing using retro-reflective sensors or the optical detection of dimensions.

### SUMMARY

It is an object of the invention to provide devices and methods which reduce or even entirely avoid damage to reference openings of components, particularly RPS receiving holes, or detect prior damage.

The centring body is intended for insertion into a reference opening, for example into an RPS receiving hole, of a component. In the process, the centring body is inserted into the reference opening along an axis.

According to the disclosure, the centring body includes an objective lens the optical axis of which coincides with the longitudinal axis of the centring body.

A centring body is understood to be an elevated structure which, in conjunction with a correspondingly configured counter-structure, serves to align the centring body and counter-structure. Specifically, the centring body may be configured so as to be pin-shaped, that is, substantially cylindrical with a tapered tip. A counter-structure is, in particular, a reference opening which only has to be formed so as to accommodate sections of the centring body. A reference opening may be a hole, but also a correspondingly formed recess.

An aspect of the invention is to equip the centring body with an objective lens as well as the associated photoconductive and optionally beamforming optical elements. Here, at least the objective lens is located on the longitudinal axis of the centring body. In this way, the optical axis of the objective lens and the longitudinal axis along which the centring body is moved are advantageously directed to a common point.

It is advantageous that the centring body has a rotationally symmetrical or symmetrical cross section so that the longitudinal axis is, at the same time, an axis of symmetry of the centring body. A centring body configured in this way does not have to be driven about the longitudinal axis at all in case of rotational symmetry, and only with regard to a permissible rotational position in case of symmetry. A permissible rotational position is given when the current alignment of the centring body permits insertion into the reference opening. A smooth insertion of the centring body into the respective reference opening is an essential and quality-determining criterion during the collection of a component by, for example, an industrial robot.

In an embodiment, the centring body according to the disclosure includes the objective lens and, optionally, a photoconductive structure such as a tube or a light-conducting fibre. A camera for capturing the image data such as, for example, a CCD camera, may be provided within or outside of the centring body. The objective lens maps light emanating from an object onto the sensor of the camera, the light path leading from the objective lens through the photoconductive structure to the sensor. In a compact embodiment of the centring body, the camera is disposed in or on the centring body. The objective lens and the tube may form a camera objective. The camera objective may, in addition to the objective lens, include other, particularly beam-forming and/or beam-deflecting optical elements. The objective lens or the camera objective and the camera may be integrally formed in a miniaturised form. Such a miniaturised camera arrangement will, hereinafter, sometimes also be referred to as a “mini camera”. The mini camera is selected with a diameter of, for example, 3 mm to 22 mm. In a particularly preferred configuration, the mini camera is pin-shaped and has an outer diameter of 3.2 mm. The centring body may include a symmetrical, particularly a rotationally symmetrical head portion. In the head portion, the objective lens and the camera may be arranged apically. Preferably, the head portion has a central bore into which the camera arrangement is inserted so that the longitudinal axis of the camera arrangement coincides with a longitudinal axis of the head portion. Preferably, a pick-up body is provided which has a central bore into which the camera arrangement is positively fitted, for example screwed or adhesively bonded. The pick-up body itself is then configured to be fixedly and positively connected to the head portion. For example, it may be contemplated that the pick-up body is inserted into and fixed in the central bore of the head portion, for example screwed or adhesively bonded to the head portion. In the head portion or in the pick-up body, an adjustment point may be provided which enables an alignment of the camera arrangement prior to its fixation, particularly with respect to the longitudinal axis of the head portion or the pick-up body. The camera arrangement may, for this purpose, be provided with an (alignment) mark. The alignment mark may predetermine an alignment of the camera arrangement with respect to its optical axis. The alignment mark may be a mechanical mark rendering an alignment of the camera arrangement with regard to the head portion or the pick-up body possible, for example an azimuth mark. Preferably, the mark is a machine-readable code, for example an RFID or QR code, encoding calibration data of the camera, for example an offset of the optical axis of the camera arrangement relative to a longitudinal axis of the camera arrangement. The calibration data may then be used to adjust the camera. Alternatively, it may be contemplated that, prior to the fixation of the camera arrangement in the head portion or the pick-up body, no separate adjustment step is performed, but that the calibration data of the camera arrangement encoded in the machine-readable code are read and transmitted to a camera software which will then incorporate the calibration data and thus potential image errors of the camera arrangement in image acquisition and/or image evaluation. In this way, the accuracy of the image evaluation may be increased. In a variant, the alignment mark may be formed on the camera arrangement as a mounting aid, for example as an individual fitting element correcting an individual alignment error of the camera arrangement. The camera arrangement or the arrangement including the camera and the pick-up body or including the camera and the head portion may be configured so as to be exchangeable. The head portion of the centring body may be separated from a central portion. The division may, for example, be defined by a circumferential bulge which may act as an insertion limiter. The central portion or the head portion may be followed by a fixing member which may include a (fast) receptacle, particularly for attaching the centring body to a robot arm, and an electrical connection, particularly for transmitting camera image data (for example, a 4-pole port for an MPEG stream), or for receiving control data.

The camera may, for example, directly communicate with an evaluation unit and a control unit via an industrial-grade single board PC on which the image processing software (IPSW) is executed and on which an interface for network integration is provided. The control unit preferably serves to drive a positioning device via which the centring body can be moved in a controlled manner. Such a positioning device may be a robot, particularly an industrial robot.

Advantageously, the centring body includes at least one fixation element which is radially adjustable relative to the longitudinal axis. Such a fixation element may, for example, be a vacuum suction device and/or a clamping device which may have inner or outer jaws. For example, such a centring body may be inserted into a reference opening and pick up components such as, for example, workpieces or semi-finished parts in this defined position. In this way, for example, moulded parts can be picked up or positioned in a defined manner. In the process, it is possible that a recess, an aperture, or a bore in the component to be picked up or to be deposited serves as the reference opening. After the insertion of the centring body into such a reference opening, the respective component may, for example, be clamped and fixed or conveyed via outer jaws.

In order to enable an alignment of the centring body, advantageously, an arrangement including a centring body according to the disclosure as well as at least one detector, for example a (CCD) camera for detecting image data using the objective lens is provided. Furthermore, an evaluation unit is provided which is configured to analyse the image data and to determine an outer shape of the hole top of the reference opening. Based on the determined outer shape, a current center of the reference opening and its position relative to the optical axis can be determined. The arrangement is, hereinafter, also referred to as a “smart measure arrangement”.

In a further embodiment, the smart measure arrangement may include a camera system including a plurality of cameras, at least one of the plurality of cameras being disposed in the centring body. Examples of such a camera system are 2D or 3D camera systems. Using various algorithms from image processing, for example, the reference opening may be detected, and an offset of the opening relative to the optical axis of the camera or the longitudinal axis of the centring body and/or the position of the opening in space relative to the apical tip of the centring body (that is, relative to its so-called “tool center point—TCP”) may be calculated as described in detail below.

With a 2D-camera system, typically, only two of the three coordinates, for example the x and the y coordinate, of a Cartesian coordinate system are detected. However, the absence of the z coordinate may be compensated in another way.

In particular, the camera arrangement may have a focus which, advantageously, may be used for determining the z coordinate. The focus may be a fixed focus. Other ways of (optionally) determining the z coordinate are feasible as well, for example with the aid of additional devices such as a laser distance measurement system.

The 3D camera system may, for example, make use of the concept of a stereoscopic camera for capturing images. It is particularly preferred that a “mini stereo camera arrangement” is integrated in the centring body in the manner already described above. The mini stereo camera arrangement includes at least two objective lenses arranged adjacent to each other, a camera, as well as a switchable optical element alternatingly directing light originating from the two objective lenses onto the image sensor of the camera in rapid temporal sequence (for example, at a frequency of 50 hertz). In some embodiments, each of the two objective lenses is associated with a separate camera. Switching the optical channels and the associated additional switchable optical element are unnecessary in this case.

The 3D camera system may include a first camera arrangement integrated in the centring body and another camera arrangement disposed outside of (adjacent to) the centring body. The other camera is preferably arranged in an acute angle of <90° relative to the centring body. The other camera may have a field of view deviating from that of the camera arranged within the centring body (particularly a larger one).

The object is solved by a method for aligning a centring body and a reference opening of a component relative to each other.

The method according to the disclosure is characterised in that a centring body according to the disclosure is moved to a detection position (also referred to as a “pre-position”) from which image data of the component are detected via a camera and using the objective lens. Based on the image data, at least one current center of the reference opening is determined by virtually adapting an outer shape of the hole top of the reference opening to a circular shape and/or to the shape of an ellipse and determining the center of a circle obtained in this way or an ellipse obtained in this way. In the process, a circle or an ellipse approximating a currently detected outer shape of the hole top of the reference opening as closely as possible is virtually searched for. Each identified current center of the reference opening is compared to the current position of the optical axis. In the process, it is examined in which position the optical axis virtually penetrates the hole top of the reference opening. Thus, a virtual penetration point of the optical axis is determined.

Based on deviations of the positions of the optical axis, that is, of the penetration point, and of the at least one current center, control commands are generated and provided for. The control commands serve to drive a positioning device via which the positions of the optical axis and of the current center are brought closer to each other when a predetermined tolerance threshold is exceeded so that the optical axis extends through the current center. For the approximation, the centring body and/or the base including the component may be moved correspondingly. The predetermined tolerance threshold is dimensioned such that falling below it is an acceptable deviation of the virtual penetration point and the current center. When the deviations of the virtual penetration point and the current center are so large that a predetermined critical threshold is reached which, when exceeded, renders an approximation of the positions of the optical axis and the current center impossible, a warning signal is set off. This may be an alarm sound, an optical warning signal and/or an interrupt of the alignment process. When the positions of the optical axis and the current center will sufficiently match, the centring body can be inserted into the reference opening on account of another control command.

In a possible embodiment of the method, a virtual adaptation of the outer shape of the reference opening to a circular shape and to the shape of an ellipse, respectively, and the determination of the respective current center is mandatory. This is followed by the determination of a difference between the coordinates of the determined current centers. The obtained difference is compared to a predetermined threshold. When the threshold is maintained, a control command for the positional adjustment of the optical axis and the current center will be generated. Here, one of the current centers may be selected, or the coordinates of the current centers are averaged and the coordinates of a resulting center are used. When the threshold is exceeded the current centers deviate too much from each other, and a warning signal is set off. This is, for example, the case when the relevant reference opening is severely deformed. A warning signal is also triggered when the reference opening is partly or fully concealed.

When an approximation of the positions of the optical axis (the penetration point) and the current center is carried out according to one of the possible embodiments of the method it may, by repeating the process steps of determining the current center, determining the difference, and comparing the difference to a predetermined threshold after the completion of the positional adjustment of the optical axis and the current center, be checked whether the positional adjustment was successful. If the positions of the optical axis and the current center are still too far away from each other another control command may be generated to continue the positional adjustment.

The control of the device or of the robot may be implemented such that the centring body is moved to the detection position. When the detection position is reached the capturing of image data, particularly in the form of an image or video recording, is activated, and, at the same time, the speed of the advance movement is strongly reduced. The adaptation of the outer shape of the hole top of the reference opening may, for example, be implemented by virtually superimposing an ideal circle onto the bright-dark transition of the reference opening, for example the RPS receiving hole.

When matching an ellipse, for example, the shortest diameter of the opening is detected as the short axis of the ellipse so as to then define the large axis of the ellipse on the center of the diameter and perpendicular to it.

The differences between the coordinates of the current centers determined via the alignment with a circular shape and the alignment with the shape of an ellipse are, under normal circumstances, approaching zero. In case of a difference of, for example, more than 0.1 mm or 0.5 mm, a disturbance, that is, in case of an RPS receiving hole, in particular, damage to this RPS-receiving hole, is to be assumed, and an (optical and/or acoustic) warning signal and/or an interrupt is triggered. The known diameter of the respective reference opening or of the receiving hole is stored, for example, in the evaluation unit as a set value. In addition, it is possible to derive information about the distance between the centring body and the reference opening based on a determined diameter and/or circumference.

The evaluation of the image data and the generation of the control commands may be performed in real time to reduce the control times. The evaluation unit may, optionally, be remotely accessed to enable a rapid identification of the cause in case of a failure.

The centring body according to the disclosure, the arrangement, as well as the method according to the disclosure are, in particular, applicable to the handling of components provided with reference openings in the form of RPS receiving holes by a robot. Here, two applications can be distinguished. On the one hand, the component may be picked up from a defined pick-up position. On the other hand, collection may be performed from a plurality of different locations or positions as it may be required, for example, in case of the automated search for a component and its collection from a component rack. In case of the collection from variable collection positions of a component rack, for example, a laser distance sensor may provide the distance information for the detection position.

Advantages of the disclosure reside in the possibility of the defined and low-wear positioning of the centring body relative to the reference opening. In this way, the conditions for inserting the centring body into the reference opening without damaging it are in place. Common process variations such as, for example, the tolerance variations of the component, a component receptacle and/or the component posture as well as temperature-related deviations can be detected and compensated. By combining various algorithms for calculating a hole center point, not only potentially pre-existing damage to the RPS receiving hole can be detected, but also crashes in case of the occurrence of malfunctions can be avoided. For example, malfunctions caused by incorrectly and/or imprecisely inserted components which, so far, inevitably always led to a crash with usually extremely unwelcome consequences are generally avoidable. But also problems such as a missing or a partly or completely obscured RPS receiving hole are detected, and a crash or imprecise component accommodation in consequence of such disturbances is therefore also excluded.

### BRIEF DESCRIPTION OF THE DRAWINGS

The invention will now be described with reference to the drawings wherein:

FIG. 1 shows a longitudinal cross-sectional view of an embodiment of a centring body according to the disclosure;

FIG. 2 shows an exploded view of another embodiment of a centring body according to the disclosure;

FIG. 3 shows an embodiment of an arrangement according to the disclosure;

FIG. 4 shows a first example of the determination of a current center by adaptation of a circular shape;

FIG. 5 shows a first example of the determination of a current center by adaptation of the shape of an ellipse;

FIG. 6 shows a second example of the determination of a current center by adaptation of a circular shape; and,

FIG. 7 shows a second example of the determination of a current center by adaptation of the shape of an ellipse.

### DESCRIPTION OF THE PREFERRED EMBODIMENTS

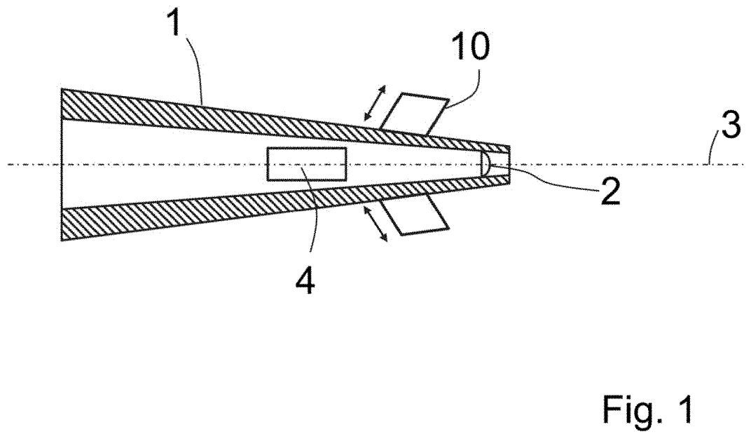

An embodiment of a centring body 1 according to the disclosure is schematically shown in a longitudinal cross-sectional view in FIG. 1. The centring body 1 is rotationally symmetrical about its longitudinal axis 3 and tapered towards one end. The tip of the centring body 1 is open. On the inside, an objective lens 2 is provided the optical axis 3 of which coincides with the longitudinal axis 3. In addition, a camera 4 by means which image data can be captured using the objective lens 2 is disposed on the inside of the centring body 1. In the embodiment of FIG. 1, the centring body further includes a clamping device 10. In the example of FIG. 1, the clamping device 10 includes three outer jaws which are radially adjustable relative to the longitudinal axis and radially evenly distributed on the centring body. The centring body 1 can thus be inserted into a reference opening to gently pick up components such as, for example, workpieces or semi-finished parts in this defined pick-up position and deposit them again at a target position.

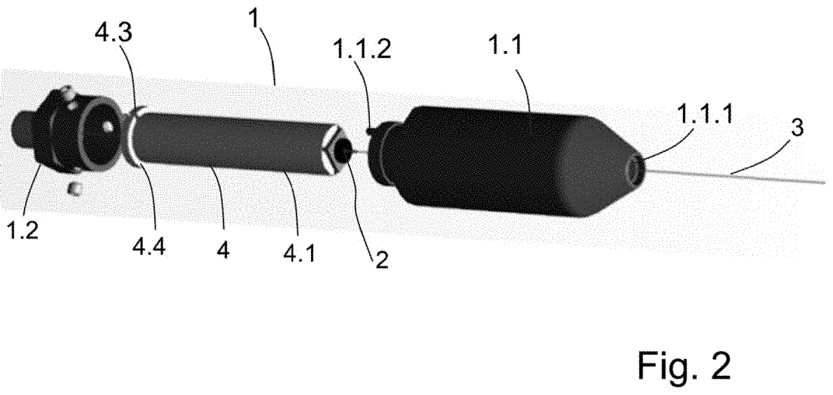

FIG. 2 shows another embodiment of the centring body 1 according to the disclosure. The centring body includes a miniaturised camera arrangement 4 (here also referred to as a mini camera) which includes an image sensor 4.2 and a camera objective. In the simplest case, the camera objective is formed by the objective lens 2. The mini camera 4 is pin-shaped and has an outer diameter of 3.2 mm. The mini camera 4 further includes an alignment mark 4.3. In the embodiment of FIG. 2, the alignment mark 4.3 is a notch formed in a circumferential collar 4.4 of the housing 4.1 of the mini camera 4. The position of the notch 4.3 on the collar 4.4 and the depth of the notch 4.3 depend on the calibration data of the mini camera 4 determined by a prior optical measurement of the mini camera 4.

The centring body 1 further includes a rotationally symmetrical head portion 1.1. The head portion 1.1 has a central bore 1.1.1 formed so as to match the outer housing diameter of the pin-shaped camera arrangement 4. The head portion 1.1 includes a projection 1.1.2 at its rear (proximal) end. The mini camera 4 is inserted into the bore 1.1.1 of the head portion and aligned so that the projection 1.1.2 of the head portion 1.1 engages with the notch 4.2 on the collar 4.3 of the camera housing 4.1. Aligned in this manner, the camera 4 is fixed to the head portion 1.1 by a ring nut. In an alternative embodiment (not shown in FIG. 2), the calibration data are stored in a database and can be read via a machine-readable code 4.2 attached to the camera housing 4.1 and transferred to the camera software which will then incorporate the calibration data and thus potential image errors of the camera arrangement 4 in image acquisition and/or image evaluation. In the embodiment of FIG. 2, the head portion 1.1 is followed by a fixing member 1.2 including a rapid receptacle for fastening the centring body to a robot arm, and an electrical connection for the transfer of camera image data.

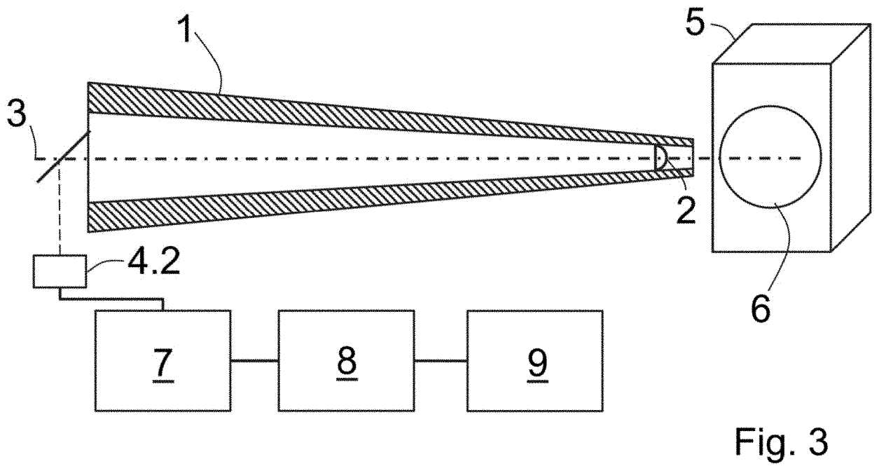

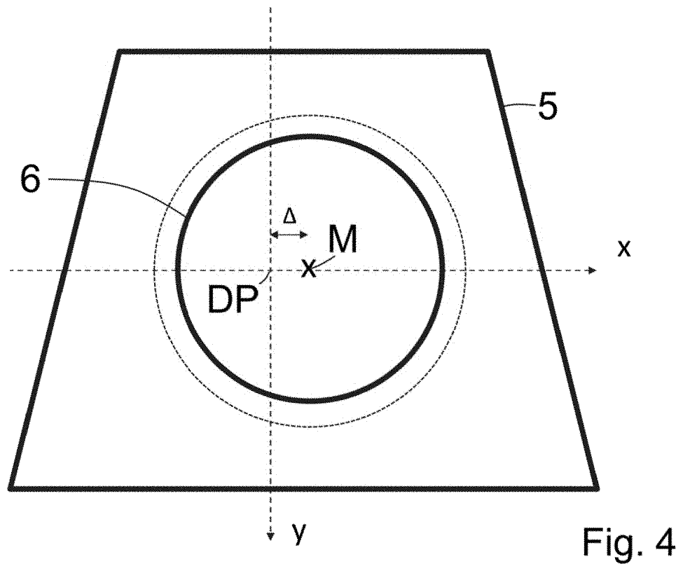

An arrangement of a centring body 1 including an objective lens 2 and a camera 4 is schematically shown in FIG. 3. The camera 4 is disposed outside of the centring body 1 and obtains image data via a light-conducting fibre which is only illustrated in outlines. The optical axis 3 is directed to a component 5 provided with a reference opening 6 in the form of a RPS receiving hole. The camera 4 is connected to an evaluation unit 7 which is configured to obtain the coordinates of at least one current center M (see FIGS. 4 to 7) of the reference opening 6 based on the received image data and to compare the coordinates of the determined current centers M. A control unit 8 serves to generate control commands depending on the results of the evaluation unit 7. A positioning device 9 via which the positions of the optical axis 3 and of a current center M can be moved closer to each other is controlled by the control commands.

In FIG. 4, the determination of a current center M is shown by way of example. A circular shape is virtually adapted to the outer shape of the hole top of the reference opening 6 by approximating a circle to the bright-dark transition of the reference opening 6. The center of the circle obtained in this way is the current center M of the reference opening 6. In addition, a penetration point DP of the optical axis 3 (not shown) at which it would penetrate the reference opening 6 is virtually determined. The respective coordinates of the current center M and the penetration point DP are determined, for example as the X and Y coordinates of a Cartesian coordinate system. Based on the difference between the coordinates of the current center M and the penetration point DP, control commands can be generated, and the penetration point DP can be adjusted to the current center M or vice versa.

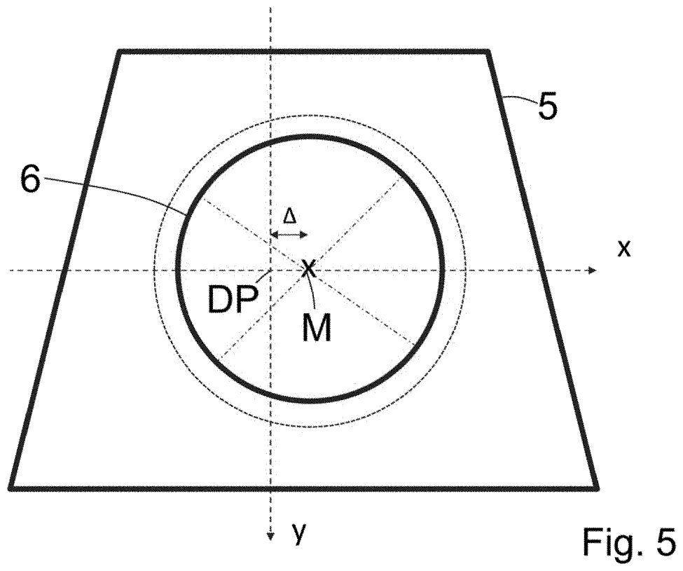

To adapt the outer shape of the hole top of the reference opening 6 to the shape of an ellipse (FIG. 5), the smallest diameter of the outer shape is identified as the small axis of an ellipse based on the image data. Based on the center of the small axis, a large axis of the ellipse orthogonal to it is determined. The current center M of the ellipse is determined and compared to the penetration point DP as described above.

It is also possible to compare the coordinates of the current centers M determined via the two approaches to each other. When the reference opening 6 has the desired shape and size the coordinates of the current centers M are very close to each other in case of round reference openings 6.

Such a situation is shown in the table below:

| | Offset to Center | | |
|---|---|---|---|
| Algorithm | X | Y | Diameter |
| Circle (FIG. 4) | 0.839 | −0.029 | 20.009 |
| Ellipse (FIG. 5) | 0.840 | −0.020 | 19.955 |
| | −0.001 | −0.009 | 0.054 |

The coordinates only deviate slightly in the X or Y direction. Also, the deviation of the determined diameter is below a predetermined threshold and is deemed tolerable.

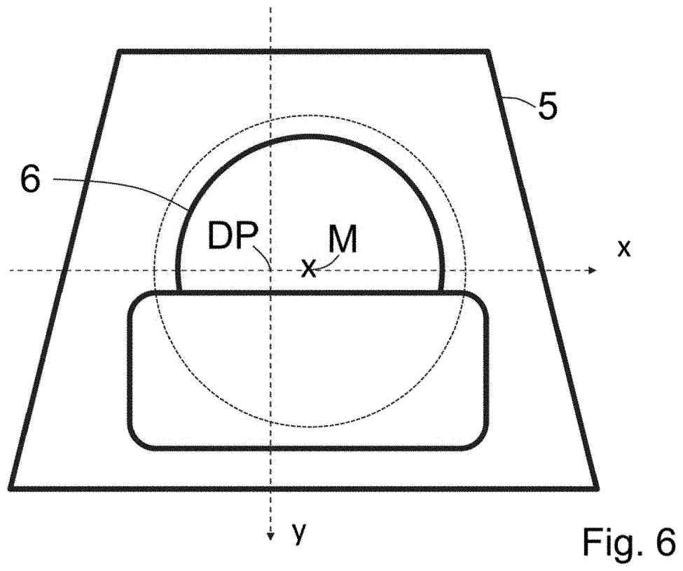

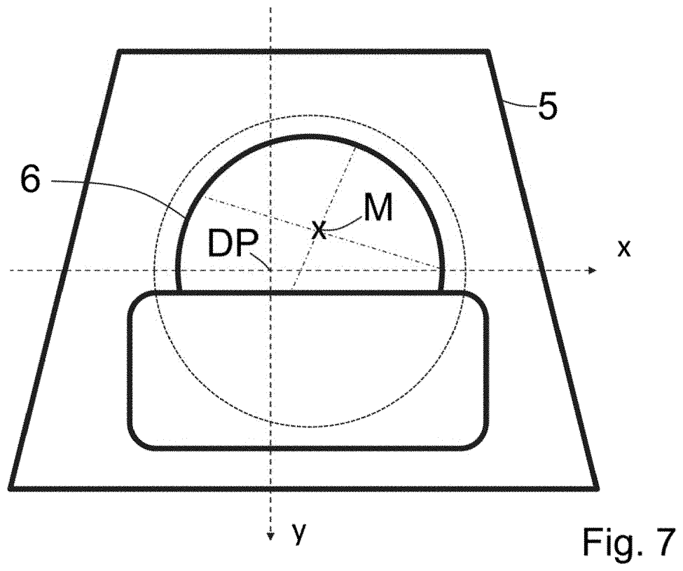

The situation illustrated in FIG. 6 (circle) and FIG. 7 (ellipse) is similar. However, the reference opening 6 is partly obstructed. In particular, the current center M determined via an adaptation to the shape of an ellipse is distinctly displaced upwards (FIG. 7). When comparing the coordinates of the current centers M determined via the two approaches significant deviations emerge which exceed a predetermined critical threshold (refer to the table below). In consequence of these deviations, a warning signal is set off.

| | Offset to Center | | |
|---|---|---|---|
| Algorithm | X | Y | Diameter |
| Circle (FIG. 6) | 0.859 | −0.025 | 20.037 |
| Ellipse (FIG. 7) | 0.972 | −2.955 | 12.730 |
| | −0.113 | 2.930 | 7.307 |

It is understood that the foregoing description is that of the preferred embodiments of the invention and that various changes and modifications may be made thereto without departing from the spirit and scope of the invention as defined in the appended claims.

### REFERENCE NUMERALS

1 centring body

1.1 head portion

1.1.1 bore

1.1.2 projection

1.2 fixing member

2 objective lens, camera objective

3 optical axis, longitudinal axis

4 camera arrangement, mini camera

4.1 camera housing

4.2 image sensor

4.3 alignment mark, code, projection

4.4 collar

5 component

6 reference opening

7 evaluation unit

8 control unit

9 positioning device

DP penetration point

M current center

What is claimed is:

1. A centring body for insertion into a reference opening of a component along a longitudinal axis defined by said centring body, the centring body comprising an objective lens defining an optical axis coincident with said longitudinal axis.

2. The centring body of claim 1, further comprising an image sensor arranged downstream of said objective lens.

3. The centring body of claim 2, further comprising an exchangeable camera arrangement incorporating said objective lens and said image sensor.

4. The centring body of claim 3, wherein said exchangeable camera is provided with an alignment mark.

5. The centring body of claim 1, wherein said longitudinal axis is simultaneously an axis of symmetry of said centring body.

6. A smart measure arrangement comprising:
a centring body for insertion into a reference opening of a component along a longitudinal axis defined by said centring body;
said centring body including an objective lens defining an optical axis coincident with said longitudinal axis;
a mini camera arranged within said centring body for capturing image data utilizing said objective lens; and,
an evaluation unit configured to evaluate said image data, to determine an outer shape of the start of said reference opening of said component and to determine a current center point (M) of said reference opening and to determine the position of said center point (M) relative to said optical axis.

7. The smart measure arrangement of claim 6, wherein at least one second camera arrangement is provided.

8. The smart measure arrangement of claim 6, wherein said reference opening is a hole or recess.

9. An industrial robot comprising:
a smart measure arrangement having a centring body for insertion into a reference opening of a component along a longitudinal axis defined by said centring body;
said centring body including an objective lens defining an optical axis coincident with said longitudinal axis;
said smart measure arrangement including a mini camera arranged within said centring body for capturing image data utilizing said objective lens; and, said smart measure arrangement further including an evaluation unit configured to evaluate said image data, to determine an outer shape of the start of said reference opening of said component and to determine a current center point (M) of said reference opening and to determine the position of said center point (M) relative to said optical axis.

10. The industrial robot of claim 9, wherein said reference opening is a hole or recess.

11. A method for aligning a centring body of a smart measuring arrangement and a reference opening of a component relative to each other, the smart measuring arrangement including: said centring body defining a longitudinal axis and having an objective lens mounted therein; said objective lens defining an optical axis coincident with said longitudinal axis; and, a camera arranged to coact with said objective lens, the method comprising the steps of:
moving said centring body to a detection position from which image data of the component are captured by said camera with said objective lens;
determining at least one current center (M) of said reference opening based on said image data by virtually matching an outer shape of the start of said reference opening to a circular shape and/or to a shape of an ellipse to arrive at a circle and/or ellipse;
determining the center of said circle determined in this way or determining the center of an ellipse determined in this way;
comparing each determined current center (M) of the reference opening to the position of said optical axis;
generating and making ready control commands based on deviations of the position of said optical axis and of at least one current center (M); and,
applying said control commands to cause a positioning device to bring the position of said optical axis and said current center (M) mutually closer when a pregiven tolerance threshold is exceeded so that said optical axis passes through said current center (M) or triggers a warning signal when a pregiven threshold value is exceeded.

12. The method of claim 11, further comprising the steps of:
virtually adapting said outer shape of said reference opening to a circular shape and to the shape of an ellipse and determining respective current center points (M);
forming a difference between the coordinates of the determined current center points (M);
comparing the formed difference to a predetermined threshold and generating at least one control command for positionally adjusting said optical axis and said current center (M) when the threshold is maintained and a warning signal when the threshold is exceeded.

13. The method of claim 11, wherein the method steps are repeated to determine the current center (M), the different formation and the comparison of the difference with a predetermined threshold after completion of the positional adjustment of the optical axis and the current center (M).

14. The method of claim 11, wherein said reference opening is a hole or recess.
